(19) United States
(12) Patent Application Publication
(10) Pub. No.: US 2020/0324635 A1
(43) Pub. Date: Oct. 15, 2020

(54) ELECTRICAL POWER UNIT AND MOTOR VEHICLE

(71) Applicant: thyssenkrupp AG, Essen (DE)

(72) Inventor: Szimandl BARNA, Gams (CH)

(73) Assignee: thyssenkrupp AG, Essen (DE)

(21) Appl. No.: 16/754,049

(22) PCT Filed: Oct. 18, 2018
(86) PCT No.: PCT/EP2018/078571

§ 371 Date: Apr. 6, 2020

(30) Foreign Application Priority Data
Oct. 20, 2017 (DE) 10 2017 124 592.8

(51) Int. Cl. B60K 1/00; B60K 7/00; B60K 11/00; B60K 17/04; B60K 17/22; B60L 7/26; B60K 17/02; B60T 1/06; B60T 5/00; B60T 1/00; F16D 65/00

(52) U.S. Cl. CPC B60K 1/00; B60K 2001/001; B60K 11/00; B60K 17/043; B60K 17/22; B60L 7/26; B60K 17/02; B60T 1/062; B60T 5/00; B60T 1/005; B60T 1/065; F16D 65/0031; B60K 2001/006; B60K 2007/0038; B60K 7/0007

(57) ABSTRACT

An electric drive unit for driving at least two wheels of a motor vehicle, which has an exclusively electrically drivable wheel axle. The wheel axle is connected to at least one electric traction motor in order to transmit a drive torque and to a central brake in order to transmit a brake torque. A transmission gear having at least two gear stages and at least one intermediate gear shaft is arranged between the traction motor and the wheel axle and the central brake is integrated in an intermediate gear shaft of the transmission gear.

The invention relates to an electric drive unit having the features of the preamble of claim 1 and a motor vehicle. Such a drive unit is known, for example, from DE 10 2005 018 907 A1.

The use of electrified drives presents braking technology with new challenges.

These include in particular:
overcoming (in comparison with the combustion engine) the high moment of inertia of the electric traction motor. This torque has to be absorbed when the vehicle is decelerated, for which reason comparatively larger brake systems than with combustion engine drives trains are required. An alternative approach is the decoupling of the electric traction motor from the drive train by means of a separate coupling, wherein the electric traction motor has further stored the energy. This may be advantageous since the traction motor acts as a flywheel;
the limited possibilities of regenerative braking: as a result of the generator mode of an electric traction motor, a brake torque can be provided; but this is the case only if a corresponding consumer is provided to do this. A consumer may be a battery which is not fully charged. However, regenerative braking is limited with full batteries, but also with almost fully charged batteries (>80%) as a result of the non-linearities of the battery which are difficult to control, for which reason the regenerative braking is not suitable for a (reliable) redundant brake system (example: alpine ascent/descent). An alternative is resistance braking, in which a separate electrical resistor is switched to the electric traction motor and converts the energy produced by the electric traction motor into heat;
the use of direct motor braking (brake devices resting on the shaft of the electric traction motor) is limited as a result of the rapidly rotating electric motors (20,000 rpm and higher), which place high demands on the brake partners (brake lining and disk) and which are too costly for industrial mass production or specific market segments.
although central brakes on the gear output have lower speeds, they have the disadvantage that the torques applied there are correspondingly higher, for which reason the required forces of the brake actuator have to be high. In particular for the use of electromechanical and electrohydraulic brakes, this is disadvantageous since they are relatively large compared with hydraulic brakes.

DE 10 2005 018 907 A1 describes a differential gear for an electrically driven drive axle having a central brake, which brakes the differential cage of the differential gear and the axle shaft wheel with respect to the differential gear housing. The central brake is to this end constructed as a wet-running multi-disk brake. The known drive axle is constructed in a complex and cost-intensive manner.

An object of the invention is to provide an electric drive unit for driving at least two wheels of a motor vehicle, which is constructed in a simple manner and which nonetheless complies to the greatest possible extent with the specific requirements which are placed on a central brake of an electric drive unit. An object of the invention is further to provide a motor vehicle.

According to the invention, this object is achieved with an electric drive unit having the features of claim 1. With regard to the motor vehicle, the object is achieved by the subject-matter of claim 21.

Specifically, the object is achieved with an electric drive unit for driving at least two wheels of a motor vehicle which has an exclusively electrically drivable wheel axle. The wheel axle is connected to at least one electric traction motor in order to transmit a drive torque and to a central brake in order to transmit a brake torque. The drive unit has a transmission gear having at least two gear stages with an intermediate gear shaft, which is arranged between the traction motor and the wheel axle. In this instance, the central brake is integrated in the intermediate gear shaft of the transmission gear. A gear stage may be formed in this instance, for example, by a spur gear pair.

The central brake is in this instance configured as a service brake.

The term service brake is intended to be understood to be a brake which is configured in contrast to parking or holding brakes (locking brake) to brake a vehicle even at high speeds and in addition to convert significant levels of energy, for example, into heat. The braking forces which are intended to be applied by a service brake are higher than those of parking brakes. The braking force is preferably higher than 40 kilonewton. The service brake is constructed to be self-releasing. Self-releasing is intended to mean in this instance that a braking force can be maintained only with the supply of external energy. The positioning device of a service brake is in contrast to parking brakes further configured to rapidly bring about the positioning operation, in particular within the range of milliseconds.

A parking brake is substantially configured to block an already stationary vehicle. A parking brake maintains a braking force without external energy supply. That is to say, a parking brake is configured to be self-locking. A parking brake has low demands in terms of actuating force and actuating speed of, for example, 20 kilonewtons and 500 milliseconds.

The invention has the advantage that, as a result of the integration of the central brake in the intermediate gear shaft of the transmission gear, the speed and the torque applied to the central brake can be adapted in an optimum manner. It is therefore possible to construct the central brake in a simple manner. Complex brake systems which have substantially the same effect are not required.

The invention relates to wheel axles which can be driven exclusively in an electrical manner or to comparable wheel axles in which the drive torque is applied exclusively by an electric traction motor (electrified drive).

In an advantageous embodiment, the wheel axle has a differential gear. In a particularly preferred manner, the drive unit has a transmission gear with at least two gear stages having an intermediate gear shaft which is arranged between the traction motor and the differential gear. By using the differential gear, it is possible, using a single motor, to drive two wheels of an axle, even in the event of the wheels having to have different rotation speeds when travelling round a bend.

In another advantageous embodiment, the drive unit has two independent wheel axles (semi-axles). The drive unit is constructed as a twin drive. The term “twin drive” is intended to mean that at least two wheels/wheel axles are driven by one traction motor. The traction motors are not directly connected to each other. The wheel axles are not directly connected to each other. In particular, a mechanical differential gear can thereby be dispensed with.

In contrast to wheel hub drives which are individual for each wheel, the drive unit according to the invention is provided to drive at least two wheels. The drive unit is not constructed inside the wheel hub. It is provided with a traction motor which is spaced apart from the wheel hub. The drive unit is not coupled as an oscillating mass to the wheel axle. The drive unit is rigidly connected to the vehicle frame.

The invention is particularly suitable for electrified vehicles with high structural space limitations, in particular electric passenger vehicles. Other vehicles in which central brakes are used are also included by the invention. A central brake is intended to be understood to be a brake unit which does not engage on the wheel directly or close to the wheel, but instead is constructed on or in the drive train.

Preferred embodiments are set out in the dependent claims.

The gear stage of the transmission gear may have an output shaft which is arranged with spacing from the wheel axle, in particular with parallel spacing from the wheel axle, and which is connected to the central brake. In contrast to brake systems close to the wheel or brake systems which are directly integrated in the wheel axle, the spacing of the output shaft from the wheel axle leads to a gain of structural space for the central brake.

In another preferred embodiment, the transmission gear has a plurality of gear stages with at least one intermediate shaft in which the intermediate shaft is connected to the central brake. As a result of the configuration and number of gear stages, the torque applied and the central brake can be adapted in an optimum manner. A relatively small closing pressing force of the central brake is sufficient to provide the required brake action for braking the vehicle and the rotating masses thereof, such as, for example, the motor, gear mechanism and wheels. Furthermore, an electric brake, for example, an electromechanical brake, can be used as a central brake.

The gear shafts are advantageously axially parallel with the shaft of the traction motor. The gear shafts are advantageously axially parallel with the wheel drive axle.

A particularly cost-effective and simple construction is produced when the transmission gear is constructed to be switch-free. The same applies when the central brake is constructed as a dry-running friction brake.

The central brake may form the only vehicle brake. That is to say, it is possible to dispense with the individual wheel brakes. Alternatively, it is also possible for the wheel axle to have individual wheel brakes in addition to the central brake. The invention thus fulfills the condition that different brake system concepts can be implemented together with an electric drive.

The central brake may also be used as a parking or holding brake. It is thereby possible to dispense with a separate parking or holding brake. In contrast to parking brakes which bring about a positive-locking blocking of the drive train, for example, by means of a locking detent, a central brake which is constructed as a friction brake and which is also used as a parking or holding brake has no play. Play is intended in this instance to mean in particular the movement range which a positive-locking locking element has between a first stop and a second stop. A limited rolling of the vehicle, as occurs in particular in holding brakes with a positive-locking parking or holding brake on a slope, does not occur or only to an insignificant degree. The central brake may to this end be constructed to be self-locking in a specific region of the positioning device. The self-locking region is not identical to a region used for the service brake function.

Preferably, the traction motor and the central brake have peripheral devices which are used together. There are thereby produced synergistic effects, which afford advantages for the functionality of the drive unit and save costs. Peripheral devices support the basic functions of the traction motor and the central brake, and relate, for example, to the mechanical protection, the control or the cooling of these components.

At least the central brake, the transmission gear and the traction motor can thus be arranged in a common housing. The drive unit is thereby compact and may where applicable be used in a modular manner.

Preferably, at least the central brake and the traction motor have a common control device. Specific control functions during braking operation can thereby be implemented in a simple manner. For example, the control device may be configured for mixed braking. Mixed braking means the division of a desired overall brake torque over different brake devices, for instance, a central brake, regenerative braking of an electric traction motor or individual wheel brakes.

This embodiment is particularly suitable on connection with the additional use of individual wheel brakes.

In another preferred embodiment, the central brake has a device for fluid cooling. The central brake can thereby be constructed in an even more compact manner. In a further preferred manner, the device for fluid cooling is connected or can be connected to the motor cooling circuit. A separate cooling pump for the central brake can thereby be dispensed with.

An individual wheel braking operation without individual wheel brakes is possible if the wheel axle has a torque vectoring unit. In this embodiment, the central brake is the only vehicle brake. It is combined with the torque vectoring unit so that the brake torque of the central brake can be adapted in an individual manner for each wheel. The term torque vectoring is intended to be understood to be an active torque distribution over the driven wheels (in contrast to passive torque distribution by the differential gear).

Storage of the kinetic energy of the traction motor during braking is possible when a clutch is arranged between the traction motor and the central brake, in particular between the traction motor, on the one hand, and the central brake and the differential gear, on the other hand. The clutch decouples the traction motor during braking so that the brake torque which has to be applied is comparatively small. The kinetic energy of the traction motor can be used in other ways, for example, for starting up.

Preferably, the clutch and the central brake can be controlled together. That is to say, during braking, the central brake is automatically separated from the traction motor.

The central brake may have a brake dust collector (open or closed) in order to prevent the abraded material produced during braking from reaching the environment. In order to reduce noise emissions, the central brake may be connected to a torsion damper.

The invention is explained in greater detail below with further details with reference to the appended drawings and embodiments.

In the drawings:

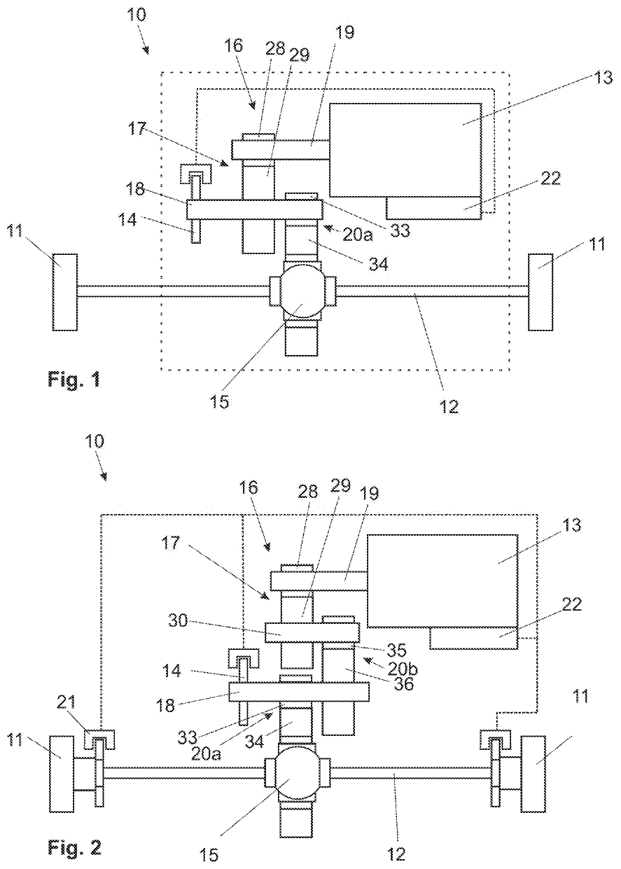

FIG. 1 is a schematic illustration of a first embodiment according to the invention with the most important components, in which the transmission gear is provided with two gear stages and an intermediate gear shaft;

FIG. 2 is a schematic illustration of a second embodiment according to the invention, in which the transmission ratio has three gear stages and two intermediate gear shafts and in addition to the central brake individual wheel brakes are provided;

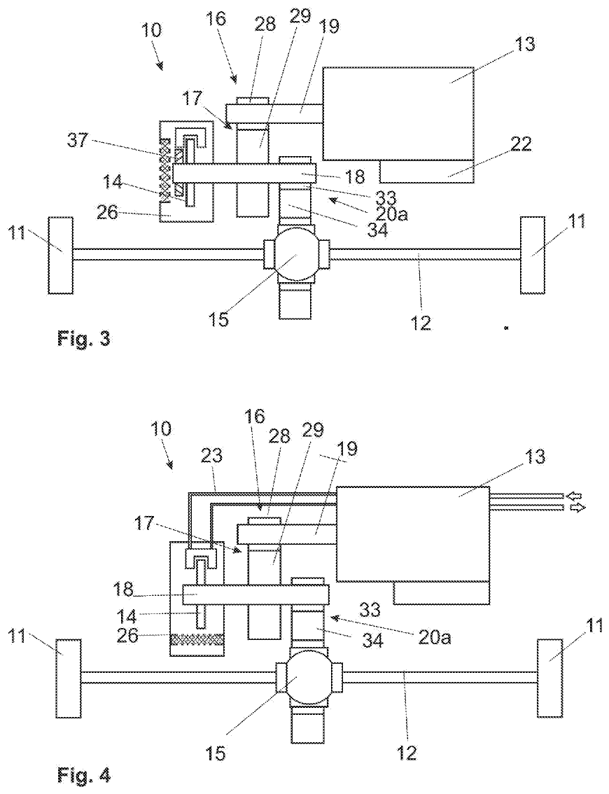

FIG. 3 is a schematic illustration of a third embodiment according to the invention in which the central brake is provided with an open filter device as a brake dust collector;

FIG. 4 is a schematic illustration of a fourth embodiment according to the invention in which the central brake is fluid-cooled and is encapsulated in a closed filter device as a brake dust collector;

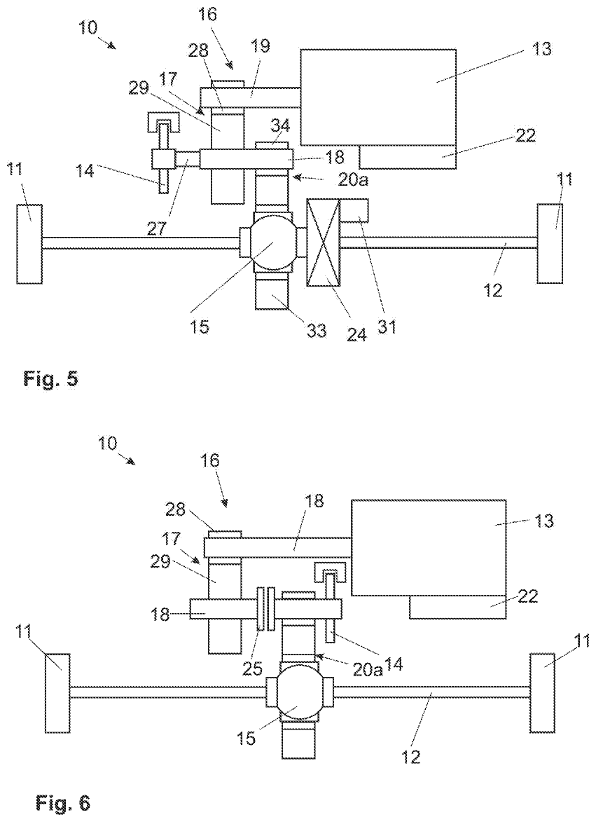

FIG. 5 is a schematic illustration of a fifth embodiment according to the invention in which the central brake is combined with a torque vectoring unit and has a torsion damper, and

FIG. 6 is a schematic illustration of a sixth embodiment according to the invention, in which a clutch is arranged between the central brake and the traction motor;

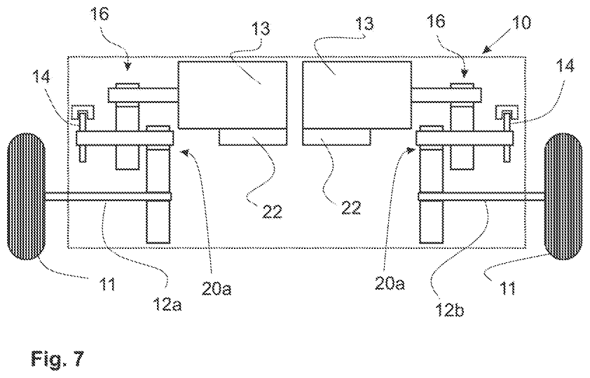

FIG. 7 is a schematic illustration of a seventh embodiment according to the invention, in which the vehicle is constructed with two tracks and the drive unit is constructed as a twin drive.

FIG. 1 shows a first embodiment of an electric drive unit 10 which is provided to drive at least two wheels 11 of a motor vehicle. The motor vehicle may, for example, be a passenger vehicle which has a wheel axle 12 which is driven exclusively electrically. Other vehicles are possible. The wheel axle 12 is connected or can be connected to the two driven wheels 11. The thick dashed line shows the system limit of the electric drive unit 10, the components of which form a module. In the context of the invention, a motor vehicle having such a drive unit 10 is further disclosed and claimed.

The drive unit 10 has an electric traction motor 13 which produces the drive torque required for driving the vehicle and which transmits it to the wheel axle 12 or the wheels 11. The drive unit 10 has a differential gear 15 which distributes the drive torque of the traction motor 13 to the wheels 11 and which compensates for the speed differences of the wheels 11. The drive unit 10 further has a central brake 14 which produces a brake torque and which transmits it to the wheel axle 12 or the two wheels 11. In contrast to the individual wheel brakes, the central brake 14 produces a central brake torque which acts on the wheels 11 together.

The central brake 14 is integrated in a transmission gear 16 which has at least two gear stages, in the embodiment according to FIG. 1 specifically a first gear stage 17 and a second gear stage 20a. The first and second gear stages are arranged between the traction motor and differential gear and coupled by means of a common intermediate gear shaft.

Specifically, the first gear stage 17 has a drive pinion 28 which is connected to the input shaft 19 of the first gear stage 17. The input shaft 19 forms at the same time the motor shaft of the traction motor 13. The first gear stage 17 further has an output toothed wheel 29 which is connected to an output shaft 18 of the gear stage 17. The output shaft 18 is in turn connected to the differential gear 15 by means of another gear stage, specifically a second gear stage 20a. The second gear stage 20a has on the output shaft 18 of the first gear stage 17 a first toothed wheel 33 which meshes with a second toothed wheel 34 which is connected to a differential cage of the differential gear 15 (not illustrated).

As can be seen in FIG. 1, the output shaft 18 of the first gear stage 17 is connected to the central brake 14. The output shaft 18 thus has two functions. On the one hand, the output shaft 18 transmits the drive torque of the traction motor 13 and, on the other hand, the drive torque of the central brake 14 in each case via the differential gear 15 to the wheels 11.

As a result of the above-described integration of the central brake 14 in an intermediate gear shaft 18 of the transmission gear 16, it is possible for the brake partners of the central brake 14 to be less heavily loaded with respect to the speed than in a central brake which is arranged directly on the motor shaft of the traction motor 13. With regard to the arrangement known per se of the central brake on the wheel axle, the torques which are intended to be braked are smaller. The central brake 14 may thus be constructed to be smaller and simpler. As a result of an appropriate selection of the transmission ratios of the gear stages 17, 20a, the central brake 14 and the relevant torque range or speed range during operation can be adapted. In this instance, the gear stages 17, 20a may have the same or different transmission ratios.

As can be seen in FIG. 1, the output shaft 18 is spaced apart in a parallel manner from the wheel axle 12. Consequently, and as a result of the integration of the central brake 14 in the transmission gear 16, structural space for the central brake 14 is obtained and structural space limitations are overcome. With a corresponding configuration of the central brake 14, the demands on the wheel brake power levels can sometimes be reduced so that the use of currently (in comparison with hydraulic wheel brakes) still very large electromechanical or electrohydraulic wheel brakes is possible.

Specifically, the central brake 14 may be constructed as a dry-running friction brake, in particular a disk brake.

The control of the central brake 14 is carried out by means of a control device 22, which takes over both the control of the traction motor 13 and the control of the central brake 14 and which is configured accordingly. It is further possible for the inverter of the traction motor 13 to be integrated in the control device 22. The signal line which connects the central brake 14 and the control device 22 is illustrated by the fine dashed line in FIG. 1.

The following synergistic effects arise in the integration of the central brake 14 in the electrical axle unit or drive unit:

The components mentioned above may be constructed in a common housing of the electric axle. The brake control device may be integrated in the motor control device or in a common control device 22 (control of the engine, inverter, brake, etc.) (see above). A more compact construction of the central brake 14 is possible by means of active fluid cooling of the brake unit, in particular by means of connection to the motor cooling circuit which is provided in any case (see below). It is further possible to operate blended braking (mixed braking) in the common control device, in particular when purely electromechanical/electrohydraulic brakes are used on the wheel and centrally. In a simple manner, it is thus possible for different operating modes of the drive train to be produced: for example, mechanical individual wheel brakes, regenerative motor brakes, central brakes or a combination thereof.

The structure of the electric drive unit 10 described in connection with FIG. 1 is accordingly implemented in the remaining embodiments and is also disclosed in connection with FIGS. 2 to 6. The invention is not limited to this specific structure.

The drive unit 10 according to FIG. 2 differs from the drive unit 10 according to FIG. 1, on the one hand, in that the transmission gear 16 is further constructed with multiple stages. Specifically, the transmission gear 16 has three stages, that is to say, the first and second gear stage 17, 20a, as in FIG. 1, and an additional third gear stage 20b. Furthermore, the drive unit 10 in provided in addition to the central brake 14 with two individual wheel brakes 21. It is also possible for the embodiment according to FIG. 1 to be provided with two individual wheel brakes 21.

The transmission gear 16 according to FIG. 2 is specifically constructed as follows. The input shaft 19 of the gear 16 is connected to the traction motor 13 and drives the first gear stage 17 by means of the drive pinion 28. The drive toothed wheel 29 of the first gear stage 17 is connected by means of an intermediate shaft 30 to the third gear stage 20b. The third gear stage 20b is arranged between the first gear stage and second gear stage 17, 20a and has a first toothed wheel 35 which is connected to the intermediate shaft 30, and a second toothed wheel 36 which is connected to the output shaft 18 of the gear 16. The output shaft 18 is, as in FIG. 1, connected, on the one hand, to the differential gear 15 and, on the other hand, to the central brake 14.

The three gear stages 17, 20a, 20b may have the same or different transmission ratios.

This embodiment has the advantage that the design freedom when the central brake 14 is positioned with respect to torque/speed range is further increased, which in particular enables the use of a central brake 14 with a slight pressing force, in particular of an electromechanical brake.

The gear 16 according to FIGS. 1, 2 cannot be switched. The same applies to the remaining embodiments of this application.

The embodiment according to FIG. 2 has in addition to the central brake 14 two individual wheel brakes 21 which are arranged close to the wheel and which are connected to the wheel axle 12. A redundant brake system is thereby provided, in which, in the event of failure of a partial system (central brake or individual wheel brakes), the other partial system can maintain a brake function at least to a limited extent. The control of the individual wheel brakes 21 is carried out by the common control device 22, which also controls the central brake 24. A mixed braking operation is thereby possible.

The drive unit 10 according to FIG. 3 is constructed in a similar manner to the drive unit 10 according to FIG. 1 and has in addition a brake dust collector 26 which in the example according to FIG. 3 is constructed as an open filter, that is to say, as a filter which is open toward the atmosphere. It is particularly advantageous for a brake dust intake or exhaust installation (impeller, ventilator, air acceleration means [37]) to be operated directly by a gear shaft.

In contrast to FIG. 3, the brake dust collector 26 according to FIG. 4 is constructed as a closed filter system which encapsulates the central brake 14. Furthermore, the central brake 14 has a device 23 for fluid cooling which is connected to the motor cooling circuit. This circuit is indicated by the double-headed arrow on the supply/discharge lines of the device 23. Another synergistic effect is achieved in that the device 23 for fluid cooling also cools the traction motor 13.

The drive unit 10 according to FIG. 5 has a torque vectoring unit 24 which is connected to the wheel axle 12 and which is arranged downstream of the differential gear 15. The torque vectoring unit 24 has an electric motor 31 and at least one torque vectoring gear mechanism 32 (distributor gear mechanism) which is connected to the wheel axle 12 for individual wheel influencing of the torque acting on the wheels 11. As a result of the combination of the central brake 14 with the torque vectoring unit 24, the individual wheel brakes can be omitted without being replaced without in this instance having to dispense with an individual wheel braking. In this instance, the main brake torque is applied by the central brake 14. The differential torque between the two wheels 11 of the drive axle 12 is produced by the torque vectoring unit 24.

Furthermore, the output shaft 18 of the gear 16 is provided with a torsion damper 27, which connects the output shaft 18 to the central brake 14. The use of the central brake 14 may have a positive effect on the noise emissions, on the one hand, as a result of the positioning “inside” the vehicle itself, on the other hand, as a result of possible encapsulation of the central brake 14 in a housing. The interposition of the torsion damper 27 between the central brake 14 and the output shaft 18 as a result of the higher degree of design freedom with respect to individual wheel brakes leads to a further improved NVH ratio (noise vibration harshness).

FIG. 6 shows an embodiment in which the output shaft 18 has a clutch 25 which decouples the traction motor 13 from the central brake 14 during the braking operation. Specifically, the coupling 25 is arranged on the intermediate gear shaft of the first gear stage 17 and second gear stage 20a and in the force path closer to the traction motor than the central brake. As a result of the clutch 25, the motor drag torque (moment of inertia in the event of braking) is decoupled, which leads to improved response behavior and higher dynamics (for example, for EPS) and/or to further downsizing potential. Advantageously, the clutch 25 and central brake 14 are in this instance acted on via a common actuator so that, in the event of braking, the clutch 25 is automatically opened. As a result of this mechanical coupling of the brake 14 and clutch 25, it is possible in particular to dispense with a separate clutch control device or an individual clutch control.

FIG. 7 shows an embodiment in which the drive unit 10 is constructed for a dual-track vehicle and is provided with a twin drive. The wheel axles (semi-axles) 12a, 12b are driven independently. Both wheels 11 of the drive axle are driven by a traction motor 13. They are not connected by means of a differential gear. A compensation for wheel speeds when travelling on bends can be carried out by controlling the traction motors. Each twin motor is connected to the wheel by means of a transmission gear 16; each transmission gear has a central brake 14. The vehicle has in the example no brakes (individual wheel brakes) which are fitted to the wheel axle 12a, 12b.

Preferably, the invention relates to an electric drive unit 10 for driving at least two wheels 11 of a motor vehicle, which has an exclusively electrically drivable wheel axle 12, wherein the wheel axle 12 is connected to at least one electric traction motor 13 in order to transmit a drive torque and to a central brake 14 in order to transmit a brake torque and has a differential gear 15 which is distinguished in particular by a transmission gear 16 having at least two gear stages 17, 20a, 20b and at least one intermediate gear shaft 18, 20 being arranged between the traction motor 13 and the differential gear 15, wherein the central brake 14 is integrated in an intermediate gear shaft 18, 30 of the transmission gear 16.

### LIST OF REFERENCE NUMERALS

10 Drive unit

11 Wheels

12 Wheel axle

12a Left wheel axle (semi-axle)

12b Right wheel axle (semi-axle)

13 Traction motor

14 Central brake

15 Differential gear

16 Transmission gear

17 First gear stage

18 Output shaft

19 Input shaft

20a Second gear stage

20b Third gear stage

21 Individual wheel brakes

22 Control device

23 Device for fluid cooling

24 Torque vectoring unit

25 Clutch

26 Brake dust collector

27 Torsion damper

28 Drive pinion

29 Output toothed wheel

30 Intermediate shaft

31 Electric motor

32 Torque vectoring gear mechanism

33 First toothed wheel of the second gear stage

34 Second toothed wheel of the second gear stage

35 First toothed wheel of the third gear stage

36 Second toothed wheel of the third gear stage

37 Air conveying means

1.-21. (canceled)

22. An electric drive unit for driving at least two wheels of a motor vehicle, comprising:
an exclusively electrically drivable wheel axle;
a central brake;
an electric traction motor connected to the wheel axle and configured to transmit a drive torque thereto and configured to transmit a brake torque to the central brake; and
a transmission gear comprising at least two gear stages and at least one intermediate gear shaft arranged between the traction motor and the wheel axle;
wherein the central brake is integrated in an intermediate gear shaft of the transmission gear.

23. The drive unit of claim 22 wherein the traction motor and transmission gear each comprise one or more shaft, said shafts constructed in an axially parallel manner with respect to an axle of the wheel drive.

24. The drive unit of claim 22 wherein of the gear stages of the transmission gear has an output shaft spaced apart from the wheel axle and which is connected to the central brake.

25. The drive unit of claim 22 wherein the transmission gear has a plurality of intermediate shafts, one of said intermediate shafts connected to the central brake.

26. The drive unit of claim 22 wherein the transmission gear is constructed to be switch-free.

27. The drive unit of claim 22 wherein the central brake is a dry-running friction brake.

28. The drive unit of claim 22 wherein the central brake forms the only vehicle brake

29. The drive unit of claim 22 wherein the wheel axle has individual wheel brakes in addition to the central brake.

30. The drive unit of claim 29 wherein the central brake and/or individual wheel brakes are an electromechanical brake.

31. The drive unit of claim 22 wherein the central brake is one or more of a service brake, a parking brake, or a holding brake.

32. The drive unit of claim 22 wherein the traction motor and the central brake have peripheral devices which are used together.

33. The drive unit of claim 22 wherein the central brake, the transmission gear, and the traction motor are arranged in a common housing.

34. The drive unit of claim 22 wherein the central brake and the traction motor have a common control device.

35. The drive unit of claim 34 wherein the control device is configured to control mixed braking.

36. The drive unit of claim 22 wherein the central brake comprises a fluid cooler.

37. The drive unit of claim 36 wherein the fluid cooler is connected to a motor cooling circuit.

38. The drive unit of claim 22 wherein the wheel axle has a torque vectoring unit.

39. The drive unit of claim 22 comprising a clutch arranged between the traction motor and the central brake.

40. The drive unit of claim 39 wherein the clutch and the central brake are configured to be controlled together.

41. The drive unit of claim 22 wherein the central brake comprises a brake dust collector.

42. The drive unit of claim 22 wherein the central brake is connected to a torsion damper.

43. A motor vehicle comprising the electric drive unit of claim 22.
